(19) United States
(12) Patent Application Publication
(10) Pub. No.: US 2026/0211565 A1
(43) Pub. Date: Jul. 23, 2026

(54) Hot Plugging Of Dynamic Random Access Memorys In Multi-Channel System On Chip Controllers

(71) Applicant: Google LLC, Mountain View, CA (US)

(72) Inventor: Aruna Kumar Tripathy, Hyderabad (IN)

(21) Appl. No.: 19/033,990

(22) Filed: Jan. 22, 2025

(51) Int. Cl. G06F 3/06

(52) U.S. Cl. CPC G06F 3/0625; G06F 3/0634; G06F 3/0673

(57) ABSTRACT

The technology is generally directed to a compute device having a multi-channel DRAM memory. Software within the device is executed by a processor to receive a request to enter a power save mode (PSM). The request may be provided by user via a user interface. The user may access user-configurable device settings, the PSM mode providing the user with an option to disable a selected number of the memory channels to save power. Upon initiating the request, data stored in the system dynamic random access memory (DRAM) is transferred to a secure persistent memory in the device. The memory controller and DRAM of the remaining active channels is reinitiated. Once reinitiated, the data saved in the persistent memory is swapped back into the remaining active DRAM. Power is isolated from the disabled memory channels to reduce power consumption. The reconfiguration of device DRAM is performed during runtime.

### BACKGROUND

Devices based on a system on chip (SoC) architecture may improve performance using a multi-channel memory model. In multi-channel memory devices, each memory channel includes a microcontroller, a physical layer (PHY) and a dynamic random access memory (DRAM). The components supporting the memory channel consume power from the device. In battery operated devices, this reduces the battery state of charge and reduces the amount of time the device can operate without recharging. When the battery state of charge becomes low, it would be beneficial for a user to select power save mode to change the device operating state where the device uses less power and conserves the remaining capacity of the battery.

### SUMMARY

The technology is generally directed to devices with multi-channel DRAM memories. A power saving mode is provided that allows some of the memory channels to be turned off during runtime to conserve power.

Aspects of the described technology include a compute system in an SoC including a computer processor, a memory in communication with the computer processor, the memory comprising a plurality of memory channels. A memory channel including a microprocessor for controlling the memory channel, a PHY, and a DRAM for storing information for the compute system. A set of compute instructions when executed by the computer processor, cause the computer processor to disable at least one of the plurality memory channels. In one example, the compute system of contains four memory channels. Software on the device allow the processor to receive from a user a request to enter a power save mode of the compute system. The user request can include an indicator representative of a number of memory channels, of the plurality of memory channels, to disable. The computer processor, responsive to instructions power gates the indicated number of memory channels to isolate power therefrom. In a secure persistent memory in the compute device, data stored in the DRAMs is received during runtime of the compute system. When entering the PSM, a processor of the compute device performs a swap of memory from the DRAMs of the plurality of memory channels to the secure persistent memory.

To initiate PSM, the device processor transfers data from the DRAMs to the secure persistent memory, then reconfigures the compute system memory based on the number of remaining active memory channels and transfers the data from the secure persistent memory back into the DRAMs of the remaining active memory channels.

The compute device processor may monitor operations of the compute system and initiate swapping of data from DRAMs to secure persistent memory and back to remaining active DRAMs based on an operating state of the compute system. In another example, the computer processor detects a hardware failure in at least one of the plurality of memory channels and initiate a power saving mode during runtime to disable the memory channel where a hardware failure has been detected.

According to a method for managing power consumption in a compute device with multi-channel memory during runtime a processor of the compute device disables one or more of a plurality of memory channels of the compute device and while continuing to run, uses a remaining number of memory channels without rebooting the compute device. The processor of the compute device receives a request from a user to trigger the disabling of the one or more memory channels of the plurality of memory channels during runtime. The user may indicate a number of the plurality of memory channels to disable during runtime. Upon receiving the request from the user to trigger the disabling of the one or more memory channels of the plurality of memory channels, the processor transfers data currently stored in dynamic random access memory (DRAM) of the plurality of memory channels to a secure persistent memory of the compute device. Then upon transfer of the data from the DRAM of the plurality of memory channels to the secure persistent memory, the processor reinitializes the memory channels that remain active based on the user request. After reinitializing the memory channels that remain active based on the user request, the processor swaps the data stored in the secure persistent memory to the memory channels that remain active based on the user request. The processor monitors an operating state of the compute system and initiates the transfer of data from the DRAMs of the plurality of memory channels to the secure persistent memory and the swapping of the data stored in the secure persistent memory to the memory channels that remain active based on the user request based on current operating state of the compute system. For example, the initiation of PSM may be performed when the compute system is in an idle state. If a hardware failure in at least one memory channel of the plurality of memory channels is detected, the processor may trigger the disabling of the at least one memory channel during runtime where the hardware failure is detected. The processor power gates the one or more memory channels of the plurality of memory channels to be disabled based on the user request to isolate power from the disabled memory channels.

### BRIEF DESCRIPTION OF THE DRAWINGS

FIG. 1 is a block diagram of a multi-channel memory in a system on chip (SoC) device according to aspects of the disclosed technology.

FIG. 2 is a block diagram of a multi-channel memory in an SoC device in power save mode according to aspects of the disclosed technology.

FIG. 3 is a process flow diagram for triggering a power save mode in a multi-channel memory in an SoC device according to aspects of the disclosed technology.

FIG. 4 is a process flow diagram of a user initiating a power save mode in a multi-channel memory SoC device according to aspects of the disclosed technology.

FIG. 5 is a block diagram of an example computing system according to aspects of the disclosure.

### DETAILED DESCRIPTION

The technology is generally directed to devices implementing a system on chip (SoC) architecture. More particularly in SoC devices having multiple memory channels, conventional devices include a separate microcontroller, physical layer (PHY) and dynamic random access memory (DRAM) for each memory channel. The duplication of microcontrollers for each memory channel require space on the chip and consume power to support the corresponding memory channel. According to the described technology, a device that allows a user to enter a power-save mode to selectively disable one or more memory channels allows the system to conserve power and battery state of charge by removing power from disabled memory channels.

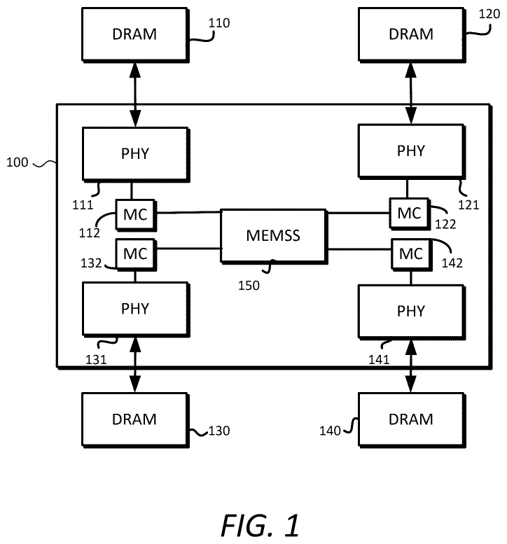

FIG. 1 is a block diagram illustrating a multi-channel memory in a device implemented as an SoC. The SoC 100 manages memory through a memory sub-system (MEMSS) 150. A device memory controller (MC) manages the DRAM memory for the memory channels. Each memory channel includes a memory controller(MC) a physical layer (PHY), and a DRAM associated with the memory channel. A first memory channel includes MC 112, PHY 111, and DRAM 110. A second memory channel includes MC 122, PHY 121 and DRAM 120. A third memory channel includes MC 132 PHY 131 and DRAM 130. Finally, a fourth memory channel includes MC 142 PHY 141 and DRAM 140.

By default, all the channels and DRAMs are active in land grid array (LGA) devices. Multi-channel DRAMs improve performance over power with memory interleaving. Even for low performance use cases that do not require higher bandwidth (BW) or higher performance, it will still consume more power than a single channel implementation. In a device having four channels of DRAM memory address hashing may be done in the device's MEMSS.

Power saving may be achieved in the device 100 by utilizing software (SW) to provide an option to disable the number of channels so that the system operates for example, one or two channels while turning off completely other channels to save power. This can be implemented by enabling an option in the user configuration to operate in a power saver mode (PSM).

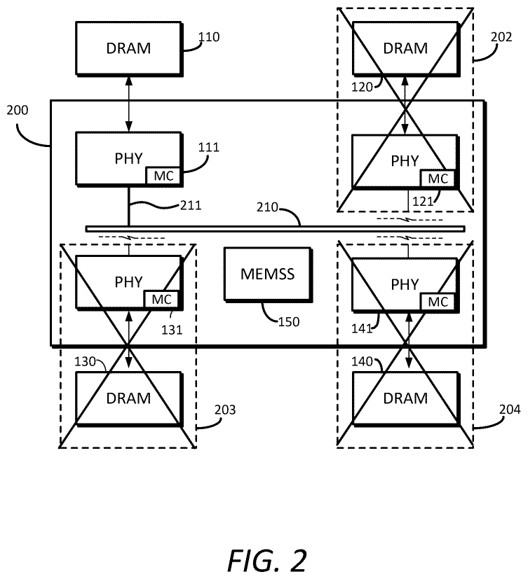

FIG. 2 is a block diagram of the SoC device of FIG. 1, showing a power save state where the device operates on one memory channel while turning off the remaining three memory channels according to aspects of the described technology. SoC 200 of FIG. 2 has the same memory channel configuration as the example of FIG. 1. However, SoC 200 is operating in power saving mode (PSM). In PSM, the second, third and fourth memory channels containing DRAM 120, DRAM 130 and DRAM 140 respectively are disabled and only memory channel with DRAM 110 is operational. The power bus 210 provides power to the components PHY 111 and DRAM 110. Power from power bus 210 is gated to block power from reaching the disabled memory channels 202, 203, 204. In PSM, SoC 200 continues to operate at a reduced performance level, while using less power. In a scenario where a user experiences a low state of charge in the battery of SoC 200, PSM may permit the user to continue to use the device until a power source is found to recharge the battery.

Ordinarily, the DRAMs 110, 120, 130, 140 cannot be disabled during runtime after booting up as it will cause issues with the current addresses being used in DRAM 110, 120, 130, 140. However, if needed a user can trigger a DRAM hot plug procedure that manages DRAM content by performing a swap with a persistent storage on the device. Persistent storage may be a secure data store in the device which is reserved for hot plugging memory channels. For example, a secure partition in the device memory may be used to temporarily store data from DRAM while performing a hot plug. In the examples that follow, it is assumed that hardware supports dynamic DRAM hot plug and memory hash programming.

In accordance with the described technology, software will provide an option to a user, such as through a user interface (UI), to trigger the system to perform DRAM hot plugging. Central double data rate (DDR) software drivers manage the current data in DRAMs ensuring proper swap out to persistent storage. Based on information received in the user request, the new configuration for system DRAM is identified. Using the required configurations, the device MC is reconfigured to operate in the requested configuration. Subsequently, when the new configuration was ready, the data swap back into the DRAMs of the available channels from persistent storage.

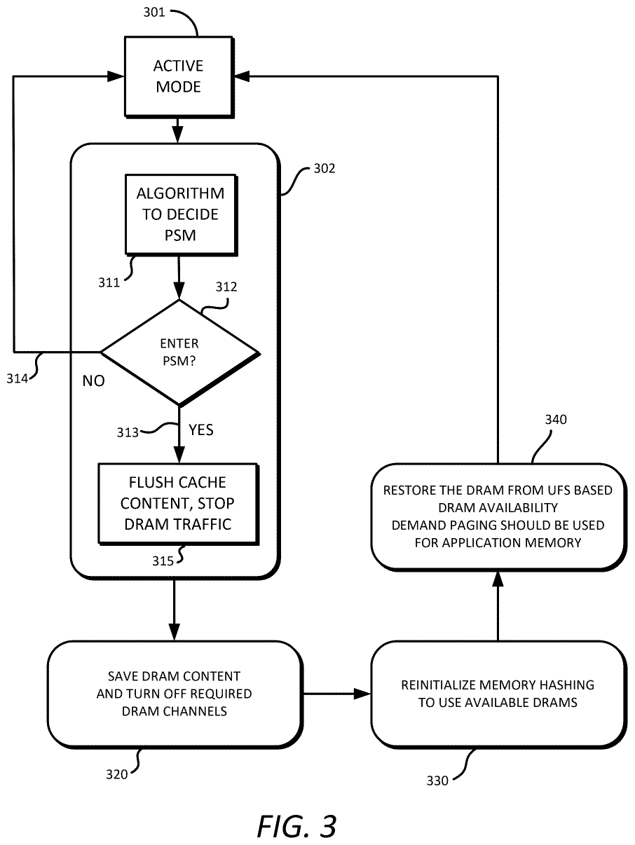

FIG. 3 is a process flow diagram illustrating entrance to a PSM according to the described technology. The device is initially running in an active mode 301. Software 302 interacts with the device during runtime and makes the determination to enter PSM 311. In some cases, the software 302 may include configuration settings that are accessible to the user. The user can indicate the desire to enter PSM. The configuration options may allow the user to indicate a number of channels to disable in PSM. The user may wish to initiate PSM when the user's device is in a low state of charge and a power source for recharging is unavailable. In other cases, the device software 302 may monitor the state of the device and make the determination that PSM should be triggered. For example, the device may detect a low state of charge and initiate PSM to extend the running time of the device as an alternative to depleting the battery and needing to shut down the device.

The determination is made whether to enter PSM 312. If there is no request to trigger PSM 314, the device returns to active mode 301.

If there is a request to enter PSM, either from the device or a user 313, the data stored in all active DRAMS must be flushed, and the system then acts to block further traffic to the DRAMs 315.

The data that is currently stored in DRAM is transferred to a secure persistent data store in the device. Once the data is transferred, the device takes actions to disable or turn off the memory channels as indicated in the request to enter PSM 320. Once the data is saved to secure persistent storage and the selected memory channels are turned off, the remaining DRAM in any active memory channels is reinitialized 330. Reinitialization includes updating the MC to control the available active memory channels, and to perform the memory address hash to prepare the active DRAMs for use.

Once the active memory channels are initialized, the data stored in the secure persistent data store is swapped back into the available DRAMs in the active memory channels 340. Once data is restored to the DRAMs the device returns to active mode 301. Device hardware (HW) can provide options for dynamic channel configurations. Additionally, the latency for swap in and swap out with persistent storage can be accounted for in order to decide when the PSM feature should be executed.

Software can decide the transition point accounting for the latency caused by the memory swap and begin to enter or exit power save mode for DRAM hot plugging. DDR central drivers halt the DRAM traffic during the hot plug using handshaking with the compute cores. Central DDR SW drivers interface with the secure persistent storage to perform saves and restores. The memory content may be organized to identify data that should be loaded, and which data can be managed through on demand paging.

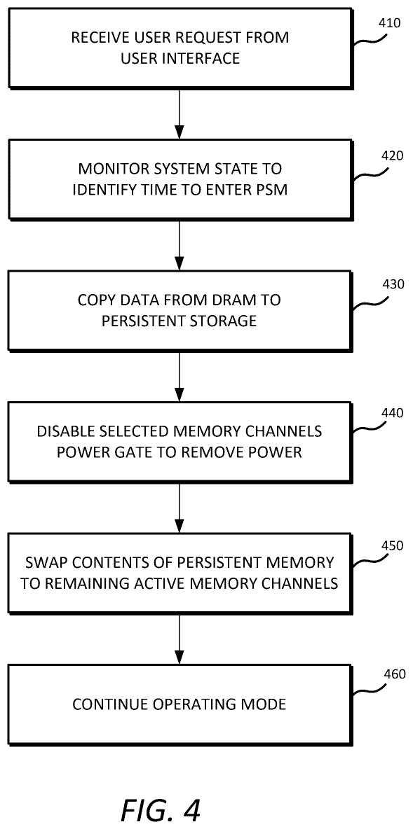

FIG. 4 is a process flow diagram for requesting the entry to power save mode by a user according to aspects of the described technology. The device receives a request from the user via a user interface 410. The device may include user-configurable settings for the device, which allow the user to request that the device enter PSM. In the configuration settings, the user may indicate the number of memory channels to remain active. The number of memory channels remaining active will affect the performance of the device at the expense of higher power consumption.

Software in the device may monitor the device operating state to determine a favorable time for entering PSM 420. A favorable time can be a time at which the device is performing minimal memory operations, such as when the device is idle or in a standby mode.

When PSM is initiated, the data currently stored in the device's DRAMs is copied to a persistent storage in the device 430. Once the data is preserved, the memory channels indicated in the user request to be turned off are disabled 440 preventing subsequent requests from arriving at the disabled channel. Power is isolated from the components of the disabled memory channel.

Once the disabled memory channels are turned off and the remaining active memory channels have been reinitialized, the contents of the persistent memory are swapped back into the DRAM of the active memory channels 450. When DRAM has been repopulated with data, the device continues in an active operating mode 460.

The entering of PSM can thus be performed during device runtime without requiring a reboot of the device. The active memory contents are preserved and restored to the new memory configuration. The remaining active memory is reinitialized during runtime to update the MC and the memory address hashing.

In a device having four memory channels, entering PSM with one remaining active memory channel will result in power savings of 3× the single memory channel. When the user selects PSM mode, the device will consume less power at the cost of performance penalty entry and exit latencies. In addition, in cases where there are physical issues with some channels or DRAMs, the board or part may still be salvaged by implementing PSM to use the remaining good memory channels.

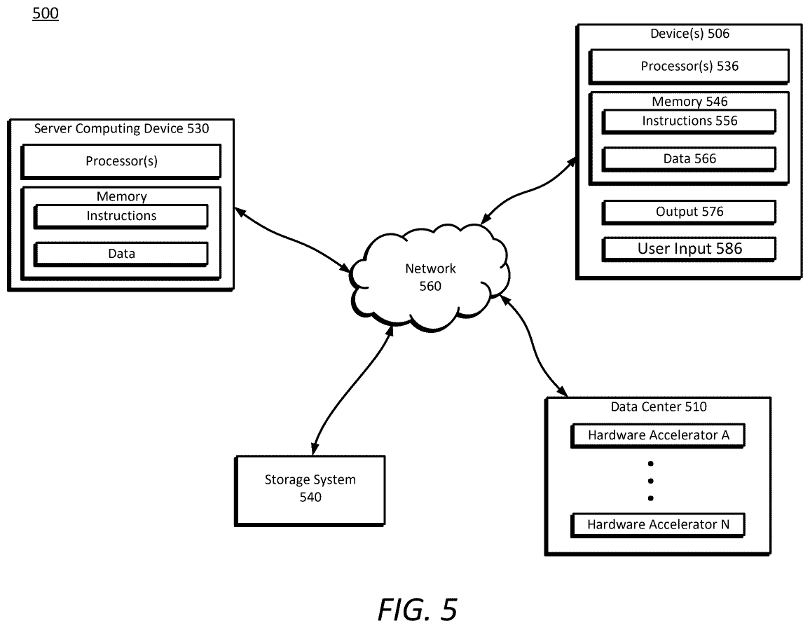

FIG. 5 illustrates an example system 500 in which the features described above may be implemented. It should not be considered limiting the scope of the disclosure or usefulness of the features described herein. In this example, system 500 may include device(s) 506, server computing device 530, storage system 540, and network 560.

Each device 506 may be a personal computing device intended for use by a respective user. The device 506 may include one or more processors 536, memory 546, data 566 and instructions 556. Each device 506 may also include an output 576, user input 586, and location sensor 596. By way of example only, devices 506 may be mobile phones or devices such as a wireless-enabled PDA, smartphones, a tablet PC, a wearable computing device (e.g., a smartwatch, AR/VR headset, smart helmet, etc.), a netbook that is capable of obtaining information via the Internet or other networks, or a smart home device, such as a home assistant, smart thermostat, smart doorbell, smart light, etc.

Memory 546 of device 506 may store information that is accessible by processor 536. Memory 546 may also include data that can be retrieved, manipulated or stored by the processor 536. The memory 546 may be of any non-transitory type capable of storing information accessible by the processor 536, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 546 may store information that is accessible by the processors 536, including instructions 556 that may be executed by processors 536, and data 566.

Data 566 may be retrieved, stored or modified by processors 536 in accordance with instructions 556. For instance, although the present disclosure is not limited by a particular data structure, the data 566 may be stored in computer registers, in a relational database as a table having a plurality of different fields and records, XML documents, or flat files. The data 566 may also be formatted in a computer-readable format such as, but not limited to, binary values, ASCII or Unicode. By further way of example only, the data 566 may comprise information sufficient to identify the relevant information, such as numbers, descriptive text, proprietary codes, pointers, references to data stored in other memories (including other network locations) or information that is used by a function to calculate the relevant data.

The instructions 556 can be any set of instructions to be executed directly, such as machine code, or indirectly, such as scripts, by the processor 536. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 536 may include any conventional processors, such as a commercially available CPU or microprocessor. Alternatively, the processor can be a dedicated component such as an ASIC or other hardware-based processor. Although not necessary, computing devices 506 may include specialized hardware components to perform specific computing functions faster or more efficiently.

Although FIG. 5 functionally illustrates the processor, memory, and other elements of devices 506 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the devices 506. Accordingly, references to a processor or device will be understood to include references to a collection of processors, devices, or memories that may or may not operate in parallel.

Output 576 may be a display, such as a monitor having a screen, a touchscreen, a projector, or a television. The display 576 of the one or more computing devices 506 may electronically display information to a user via a graphical user interface (“GUI”) or other types of user interfaces. For example, as will be discussed below, display 576 may electronically display query results.

The user input 586 may be a mouse, keyboard, touch-screen, microphone, or any other type of input.

The devices 506 can be at various nodes of a network 560 and capable of directly and indirectly communicating with other nodes of network 560. Although one device is depicted in FIG. 5, it should be appreciated that a typical system can include one or more devices, with each device being at a different node of network 560. The network 560 and intervening nodes described herein can be interconnected using various protocols and systems, such that the network can be part of the Internet, World Wide Web, specific intranets, wide area networks, or local networks. The network 560 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 500 may include one or more server computing devices 530 having a plurality of computing devices, e.g., a load balanced server farm, that exchange information with different nodes of a network for the purpose of receiving, processing and transmitting the data to and from other computing devices. For instance, one or more server computing devices 530 may be a web server that is capable of communicating with the one or more client computing devices 506 via the network 560. In addition, server computing device 530 may use network 560 to transmit and present information to a user of one of the other computing devices 506.

Server computing device 530 may include one or more processors, memory, instructions, data, etc. These components operate in the same or similar fashion as those described above with respect to computing device 506.

According to some examples, the server computing device 530 may be connected over the network to a data center 510 housing any number of hardware accelerators. The data center 510 can be one of multiple data centers or other facilities in which various types of computing devices, such as hardware accelerators, are located. Computing resources housed in the data center can be specified for repeated results monitoring, including identifying repeated query results, or the like.

The server computing device 530 can be configured to receive queries from the client computing device 506 on computing resources in the data center 510. For example, the environment can be part of a computing platform configured to provide a variety of services to users, through various user interfaces and/or application programming interfaces (APIs) exposing the platform services. The variety of services can include identifying content responsive to the query, determining whether query results are repeated query results, or the like. The client computing device 506 can transmit input data associated with a query. The server computing device 530 can receive the input data and, in response, identify and provide for output query results. When identifying the query results, the server computing device 530 can generate a signature for the query results. The generated signature may be compared to other signatures associated with the query results and/or historical query signatures. Based on the comparison, the server computing device 530 can determine whether the query results are repeated query results. In examples where the query results are repeated query results, the server computing device 530 can enable one or more preventative measures.

As other examples of potential services provided by a platform implementing the environment, the server computing device can maintain a variety of models in accordance with different constraints available at the data center. For example, the server computing device can maintain different families for deploying models on various types of TPUs and/or GPUs housed in the data center or otherwise available for processing.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed on its software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a stand-alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purposes logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A compute system in a system on chip (SoC) comprising:
a computer processor;
a memory in communication with the computer processor, the memory comprising a plurality of memory channels, a memory channel comprising:
a physical network layer (PHY);
a microcontroller for performing PHY level operations;
a dynamic random access memory (DRAM) for storing information for the compute system;
a memory controller (MC) for controlling the DRAM over PHY; and
a set of compute instructions, that when executed by the computer processor, cause the computer processor to disable at least one of the plurality memory channels.

2. The compute system of claim 1, further comprising:
four memory channels.

3. The compute system of claim 1, further comprising:
compute instructions that, when executed by the computer processor, cause the processor to receive from a user a request to enter a power save mode of the compute system.

4. The compute system of claim 3,
the received request from the user comprising an indicator representative of a number of memory channels, of the plurality of memory channels, to disable.

5. The compute system of claim 4, further comprising:
a set of compute instructions that when executed by the computer processor cause the computer processor to power gate the indicated number of memory channels to isolate power therefrom.

6. The compute system of claim 5, further comprising:
a secure persistent memory for receiving data stored in the DRAMs during runtime of the compute system.

7. The compute system of claim 6, further comprising:
a set of compute instructions that when executed by the computer processor cause the computer processor, upon receiving the request from a user to enter the power saving mode, to perform a swap of memory from the DRAMs of the plurality of memory channels to the secure persistent memory.

8. The compute system of claim 7, further comprising:
a set of compute instructions that when executed by the computer processor cause the computer processor to:
transfer data from the DRAMs to the secure persistent memory;
reconfigure the compute system memory based on the number of remaining active memory channels; and
transfer the data from the secure persistent memory back into the DRAMs of the remaining active memory channels.

9. The compute system of claim 8, further comprising:
a set of compute instructions that when executed by the computer processor cause the computer processor to:
monitor operations of the compute system; and
initiate swapping of data from DRAMs to secure persistent memory and back to remaining active DRAMs based on an operating state of the compute system.

10. The compute system of claim 9, further comprising:
a set of compute instructions that when executed by the computer processor cause the computer processor to:
detect a hardware failure in at least one of the plurality of memory channels; and
initiate a power saving mode during runtime to disable the memory channel where a hardware failure has been detected.

11. A method for managing power consumption in a compute device with multi-channel memory comprising:
during runtime, in a processor of the compute device, disabling one or more of a plurality of memory channels of the compute device; and
continuing to run, using a remaining number of memory channels without rebooting the compute device.

12. The method of claim 11, further comprising:
in a processor of the compute device, receiving a request from a user to trigger the disabling of the one or more memory channels of the plurality of memory channels during runtime.

13. The method of claim 12, further comprising:
receiving at the processor as part of the request from the user, an indicator representing a number of the plurality of memory channels to disable during runtime.

14. The method of claim 13, further comprising:
upon receiving the request from the user to trigger the disabling of the one or more memory channels of the plurality of memory channels, the processor transferring data currently stored in dynamic random access memory (DRAM) of the plurality of memory channels to a secure persistent memory of the compute device.

15. The method of claim 14, further comprising:
upon transfer of the data from the DRAM of the plurality of memory channels to the secure persistent memory, the processor reinitializing the memory channels that remain active based on the user request.

16. The method of claim 15, further comprising:
upon reinitializing the memory channels that remain active based on the user request, the processor swapping the data stored in the secure persistent memory to the memory channels that remain active based on the user request.

17. The method of claim 16, further comprising:
upon receiving the request from the user to trigger the disabling of the one or more memory channels of the plurality of memory channels, the processor monitoring an operating state of the compute system; and
initiating the transfer of data from the DRAMs of the plurality of memory channels to the secure persistent memory and the swapping of the data stored in the secure persistent memory to the memory channels that remain active based on the user request based on current operating state of the compute system.

18. The method of claim 17, wherein the initiating the transfer of data from the DRAMs of the plurality of memory channels to the secure persistent memory and the swapping of the data stored in the secure persistent memory to the memory channels that remain active based on the user request is performed when the compute system is in an idle state.

19. The method of claim 18, further comprising:
detecting, by the processor, a hardware failure in at least one memory channel of the plurality of memory channels; and
triggering, by the processor, the disabling of the at least one memory channel during runtime where the hardware failure is detected.

20. The method of claim 18, further comprising:
in the processor, power gating the one or more memory channels of the plurality of memory channels to be disabled based on the user request to isolate power from the disabled memory channels.
